(19) United States
(12) Patent Application Publication
(10) Pub. No.: US 2014/0372274 A1
(43) Pub. Date: Dec. 18, 2014

(54) COUNTDOWN TIMING IN FINANCIAL INSTRUMENT TRADING HAVING A REPORTING OBLIGATION

(71) Applicant: Chicago Mercantile Exchange Inc., Chicago, IL (US)

(72) Inventor: James David Russell Barry, London (GB)

(21) Appl. No.: 13/918,396

(22) Filed: Jun. 14, 2013

(51) Int. Cl. G06Q 40/04

(52) U.S. Cl. CPC G06Q 40/04
USPC 705/37

(57) ABSTRACT

A computer implemented method of facilitating a financial instrument transaction involving a market participant includes generating a first interface for the market participant configured for entry of data indicative of the financial instrument transaction, capturing data indicative of a timing of the financial instrument transaction based on the data entered via the first interface, determining, with a processor, a timeframe for reporting a price of the financial instrument transaction based on the data indicative of the timing, and generating a second interface for the market participant in which a timer is displayed, the timer being configured to display a time relative to the timeframe.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement.

Typically, the Exchange provides a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Trades involving futures contracts and other financial instruments are often conducted in large blocks of securities. A block trade may include a number of legs in different instruments (e.g., futures with different delivery dates). The price of each leg is established in a block trade. In some markets, Exchange rules mandate the reporting of the leg prices within a given time period of finalizing the block trade. Traders failing to report the pricing within the time period are typically fined.

### BRIEF DESCRIPTION OF THE DRAWINGS

FIG. 1 depicts an illustrative computer network system that may be used to implement transaction management with countdown timing in accordance with the disclosed embodiments.

FIG. 2 a block diagram of an exemplary implementation of the system of FIG. 1 for transaction management with countdown timing in accordance with the disclosed embodiments.

FIG. 3 depicts a flow chart showing operation of the system of FIGS. 1 and 2.

FIG. 4 shows an illustrative embodiment of a general computer system for use with or in the system of FIGS. 1 and 2.

FIG. 5 shows an exemplary implementation of the disclosed embodiments.

### DETAILED DESCRIPTION

The disclosed embodiments relate to an interface in which a countdown timer is provided to facilitate financial instrument trading. The countdown timer may provide a visual indicator to a broker or other market participant. The countdown timer may display a time relative to a deadline for reporting a price of a financial instrument agreed to in a trade. The countdown timer may help traders meet an obligation to submit price data to the Exchange for trades, such as block trades, within a certain timeframe of the transaction being executed or finalized. The timeframe may be about 5-15 minutes depending on the financial product being traded. The disclosed embodiments may allow brokers and other market participants to avoid fines or other penalties for exceeding the timeframe. Brokers may also avoid a cumbersome process in which paper tickets are manually stamped with a current time once the transaction is finalized, and handed to a trade entry clerk. The disclosed embodiments may thus provide an electronic trading environment that may improve processing time in addition to facilitating the satisfaction of price reporting obligations.

The interface having the countdown timer may be integrated with an interface that provides a trade book and/or trade entry form for brokers. Use of the trade entry form may initiate a transaction process in which the elapsed or remaining time to submit data regarding the transaction is presented via the trade book. In some cases, the interfaces for the trade book and the trade entry form may be integrated with one another.

While the disclosed embodiments may be discussed in relation to trading in futures contracts, it will be appreciated that the disclosed embodiments may be applicable to other financial instruments, such as interest rate swaps or other swaps. The disclosed methods and systems may be used in connection with the trading of a wide variety of financial instruments, such as securities products, e.g., stocks or bonds, and over-the-counter (OTC) derivative products, e.g., interest rate swaps (IRS), credit default swaps (CDS), currency forwards, commodity swaps, equity swaps, etc. The disclosed methods and systems may be applied to many different equity, options, or futures trading systems or other markets now available or later developed. For example, the disclosed methods and systems may be used in the context of various interest rate, currency, and physical commodity markets, such as agricultural markets.

It will be appreciated that brokers, traders, or other entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the Exchange.

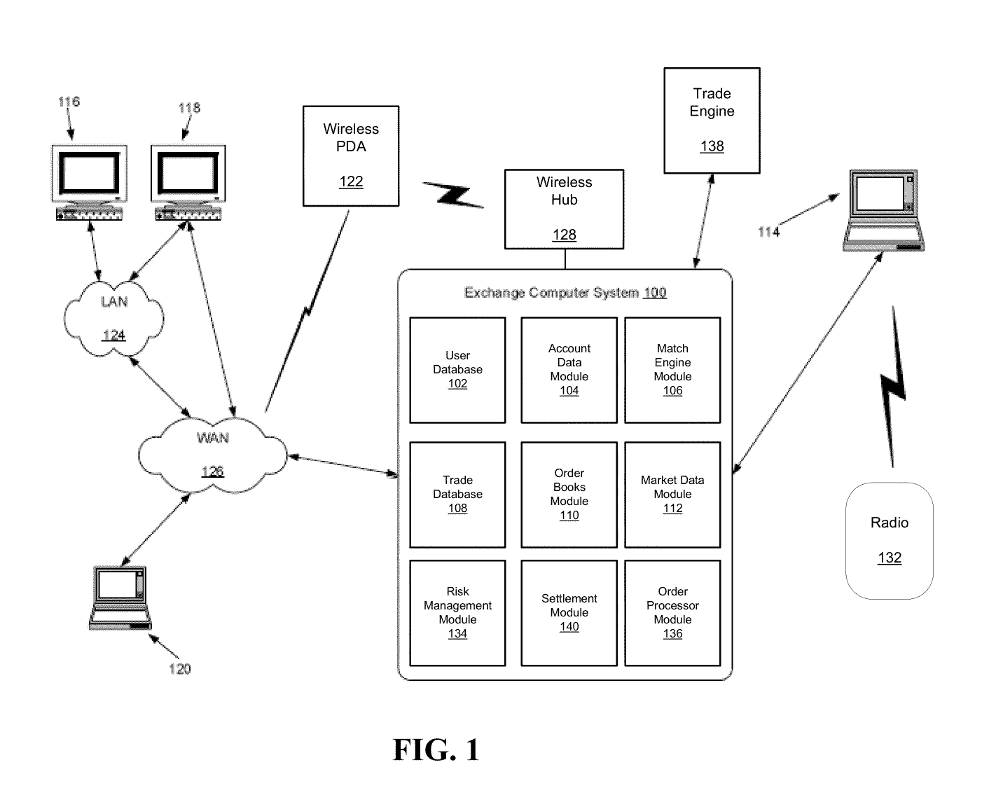

With reference now to the drawing figures, an exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

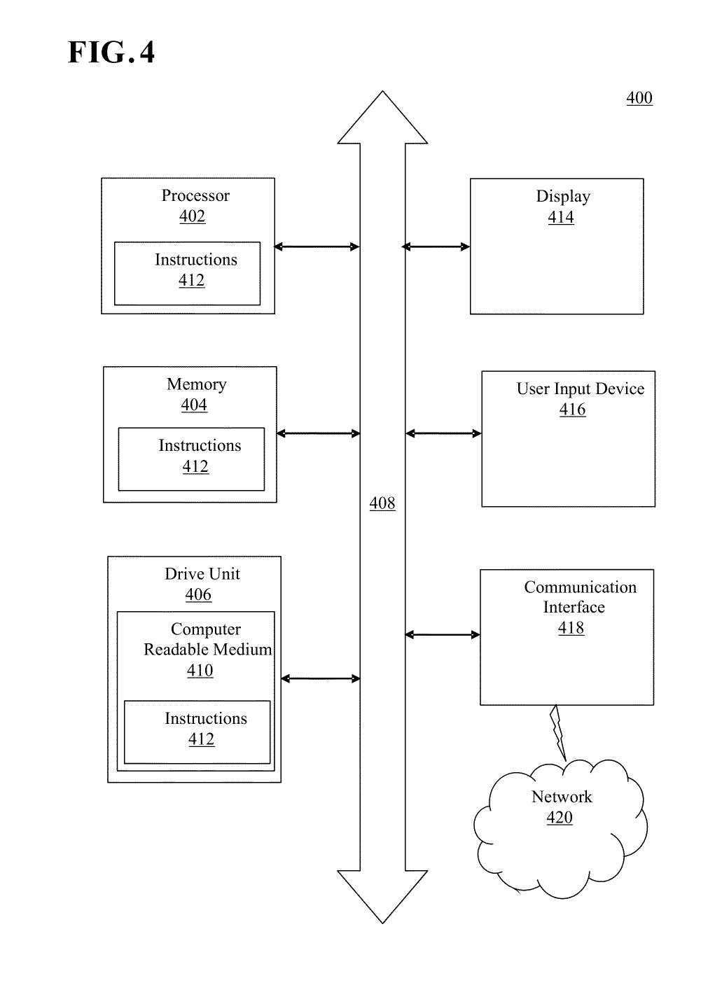

The exchange computer system 100 may be implemented with one or more mainframe, desktop or other computers, such as the computer 400 described below in connection with FIG. 4. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. The match engine module 106 may be in communication with one or more of the local area network 124, the wide area network 126, or other elements of the exchange computer system 100 to receive data indicative of the orders from the market participants.

A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant. The risk management module 134 may be configured to administer, manage or maintain one or more margining mechanisms implemented by the exchange computer system 100.

An order processing module 136 may be included to decompose delta-based and bulk order types for processing by the order book module 110 and/or the match engine module 106. The order processing module 136 may also be used to implement one or more procedures related to clearing an order. In some cases, the order processing module 136 may communicate with one or more computer devices described below in connection with a reporting obligation for transaction data for the orders.

In the example of FIG. 1, the exchange computer system 100 also includes a settlement module 140 (or settlement processor or other payment processor) to provide one or more functions related to settling or otherwise administering transactions cleared by the Exchange. For example, the settlement module 140 may be configured to communicate with the trade database 108 (or the memory(ies) on which the trade database 108 is stored) and/or to determine a payment amount based on a spot price, the price of the futures contract or other financial instrument, or other price data, at various times.

The exchange computer system 100 may include one or more additional modules or processors, including, for instance, a volume control module configured to, among other things, control the rate of acceptance of mass quote messages. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may include a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device, touchpad, touchscreen, or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In some embodiments, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

The users of the exchange computer system 100 may include one or more traders or other market participants, which may maintain a market by providing to the exchange computer system 100 constant bid and offer prices for a financial instrument via one of the computer devices depicted. The exchange computer system 100 may also exchange information with other trade engines, such as trade engine 138. Additional computers and systems may be coupled to the exchange computer system 100. Such computers and systems may include clearing, regulatory, and fee systems.

The operations of computer devices and systems shown in FIG. 1 may be controlled by computer-executable instructions stored on a non-transitory computer-readable storage medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

A transaction, such as a block trade, involving one or more financial instruments may be facilitated through a number of interfaces generated at the computer devices 114, 116, 118, 120. Each interface may be presented via a display of the computer devices. In some cases, one or more interfaces are generated via a client-server framework. A component of the exchange computer system 100 may act as a server for one or more of the computer devices 114, 116, 118, 120 acting as a client. For example, the order processor module 136 and/or the order books module 110 may provide services and logic to support the entry, processing, and other handling of orders. A service provided by the order processor module 136 may include the generation of one or more interfaces to support the entry of order data (e.g., financial instrument type, quantity, price, time, etc.). The interface(s) may include a trade entry form. A service of the order books module 110 may include the generation of one or more interfaces to support the display of trade book data to a user. These services may be provided via client-side applications executed on one of the computer devices 114, 116, 118, 120. Such applications may access data, logic, and/or instructions on a server (e.g., server module) of the exchange computer system 100 to provide the interfaces. Alternatively or additionally, the services may be implemented via a client-side browser responsive to data, logic, and/or instructions provided by the server. The location of the logic, instructions, and data for implementing the services may vary. For example, some or all of the instructions, logic, and/or data to generate the interfaces may be resident on one of the computer devices 114, 116, 118, 120.

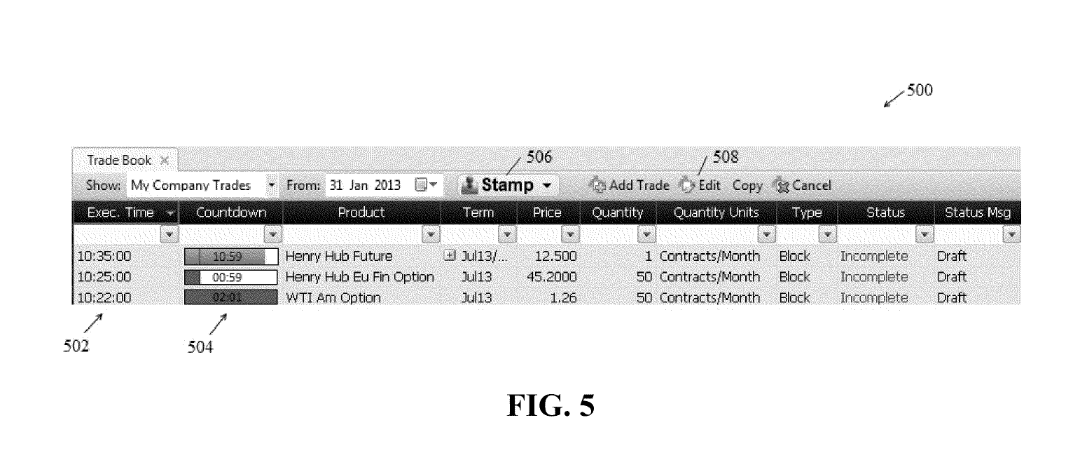

The interfaces may include a trading interface and a trade book interface. Each interface is generated at one of the computer devices 114, 116, 118, 120 for a particular broker, trader, or other market participant involved in the transaction. The trading interface is configured for entry of data indicative of the financial instrument transaction. The data may specify the type of financial product, quantity, price, and/or other transaction data. The trade book interface may be configured to display the transaction data once the transaction is finalized. For example, the trade book interface may display the transaction data once the terms of the trade are sufficiently established. In other examples, the trade book interface displays transaction data for draft and other trades in which brokers have incomplete transaction data. The trade book interface may also display data regarding the timing of such transactions. The timing of the transaction may be determined based on the entry of the transaction data via the trading interface. An example of the trade book interface is shown in FIG. 5 and described below. One or both of the interfaces may be integrated or generated in connection with an electronic trading system or platform, such as CME Direct (CME Group, Inc.) for the Chicago Mercantile Exchange.

The trading and trade book interfaces may replace paper ticket processes for block and other trade booking. The trading interface may be configured to initiate a trade and capture the timing data associated with the timestamps of the paper ticket process. In the paper ticket process, a ticket is given to a broker receiving an order. The ticket is stamped with the order time, and a customer code, product, and buy/sell quote are written on the ticket. Once a matching offer is received, the broker stamps the current time on the ticket and fills in the remainder of the ticket. With block trades, leg prices are then agreed upon, written on the ticket, and the ticket is stamped a third time. A trade entry clerk is then given the paper ticket and enters the trade for clearing.

The timestamps on the paper ticket subject the market participant to a price reporting obligation. For example, block trades may result in an obligation requiring prices to be reported to the Exchange for public dissemination within 15 minutes of the trade being finalized (e.g., leg prices agreed upon). Other timeframes or time periods may be applicable in other types of trades. The reporting obligation may be much shorter than the deadline for submitting the trade into clearing.

The interfaces may be integrated to any desired extent. In some cases, the interfaces may be accessible from one another or be otherwise linked to one another. In the example shown in FIG. 5, a trade entry form of the trading interface may be launched by selecting an “Add Trade” function made available in the trade book interface. The interfaces may facilitate financial instrument transactions in additional ways. For example, the trade book interface may provide historical information on past transactions. Further interfaces may be generated.

The computer devices 114, 116, 118, 120 may communicate with a number of the above-referenced modules of the exchange computer system 100 in generating the trading interface and the trade book interface. In some embodiments, the match engine module 106, the trade database 108, the order processor module 136, and/or the order books module 110 may be accessed to obtain and/or store transaction data (and/or other data used to determine the transaction data). In an example involving a block trade, the matching of bids and offers for each leg of the block trade are entered manually. In other cases, the match engine module 106 or other module may be used to automate trade matching, e.g., match bids and offers for each leg of the block trade. The price, quantity, and other transaction data may be stored in the trade database 108. In some cases, the order processor module 136 may support the generation of one or both of the interfaces and/or otherwise support transmission of transaction data between the computer device 114, 116, 118, 120 and the exchange computer system 100. The order processor module 136 or other module(s) of the exchange computer system 100 may monitor the transaction data (e.g., timestamps) for compliance with reporting and/or other obligations.

It will be appreciated the disclosed embodiments may be implemented by or in connection with a different or separate module of the exchange computer system 100 (or a separate computer system coupled with the exchange computer system 100) other than those shown in FIG. 1 and/or described above. For example, the disclosed embodiments may be implemented by or in connection with a module of the exchange computer system dedicated to processing or managing certain types of trades, such as block trades.

As described herein, the disclosed embodiments may be implemented as a centrally accessible system or as a distributed system. For instance, one or more aspects of the disclosed embodiments may be implemented by one of the computer devices 114, 116, 118, 120. The implementation of such aspects may be separate from, or integrated with, the operation of the modules of the exchange computer system 100 to any desired extent. Distributed processing may reduce processing demands presented by the management of transactions, such as block trades. Addressing the management of block trades and other transactions solely at the exchange computer system 100 may drain processing time and resources from other exchange functions. For example, the processing demands presented by the order books module 110 may be reduced as a result of implementing the transaction management techniques of the disclosed embodiments.

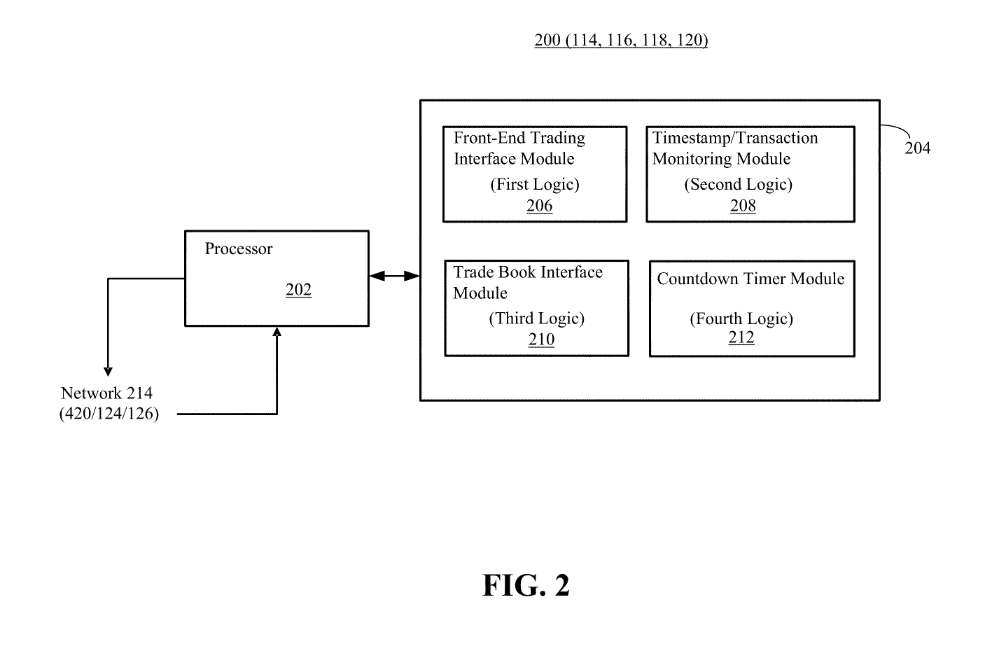

As described below in connection with the exemplary embodiments of FIGS. 2 and 5, one or more of the modules of the Exchange computer system 100 and/or one of the computer devices 114, 116, 118, 120 may be configured to facilitate a financial instrument transaction through countdown or other timing for a market participant. The countdown timing may be useful in connection with transactions having one or more reporting obligations relative to the time at which the transaction is finalized. For example, compliance with current regulations for block trades involves reporting the price(s) for a particular transaction within a specified timeframe (e.g., five to 15 minutes) of the time at which the market participants finalize the transaction.

The countdown timing may be useful in connection with other timeframes (e.g., non-regulatory timeframes). For example, the countdown timing may assist market participants in complying with rules of the Exchange.

To facilitate compliance with such regulations, the module(s) of the Exchange computer system 100 and/or the computer device(s) 114, 116, 118, 120 are configured via, e.g., respective computer-readable instruction sets, as described below to, for instance, (1) generate a trading interface for the market participant for entry of data indicative of the transaction, (2) capture data indicative of a timing of the transaction based on the data entered via the trading interface, (3) determine a timeframe for reporting one or more prices of the transaction based on the captured timing data, and (4) generate a trade book interface for the market participant in which a timer (e.g., countdown timer) is displayed. As described below, the countdown timer is configured to display a time relative to the timeframe determined for reporting the price(s) of the transaction. For example, the displayed time may be indicative of an elapsed time, a time remaining, or other relative time.

FIG. 2 depicts a block diagram of a computer system 200 for management of a financial instrument transaction with countdown timing. The computer system 200 may correspond with, or include, one of the computer devices 114, 116, 118, 120. The computer system 200 may alternatively correspond with, or additionally include, one or more of the above-described modules of the exchange computer system 100, such as the order books module 110 and the order processor module 136. As used herein, an Exchange supports the receipt, administration, management, and/or other processing of transactions of financial instruments involving market participants. The computer system 200 of FIG. 2 is configured to facilitate such transactions by helping the market participants comply with one or more reporting obligations, such as those directed to reporting price data for such transactions within a predetermined timeframe. To comply with such obligations, the computer system 200 is configured to present a countdown timer in connection with each such transaction. The countdown timer is presented via one of the interfaces generated for the market participant. As described below, the countdown timer may indicate the time remaining within a timeframe for reporting the price information.

The computer system 200 includes a processor 202 and a memory 204 coupled therewith which may be implemented as a processor 402 and memory 404 as described below with respect to FIG. 4. The computer system 200 further includes a number of logic units. In this embodiment, the computer system 200 includes four logic units directed to implementing the countdown timing transaction management techniques of the disclosed embodiments. Each logic unit may be implemented as a discrete software module. Each module may include or correspond with a component of an instruction set resident on one of the computer devices 114, 116, 118, 120. Alternatively, the logic unit may be implemented via an instruction set executed via a browser of one of the computer devices 114, 116, 118, 120. The instruction set may be provided to the browser via a client-server relationship. In some cases, the exchange computer system 100 of FIG. 1 may provide the server functionality of the relationship. The modules and/or instruction sets may be integrated to any desired extent. Additional modules may be provided. For example, separate modules may be provided for monitoring the transaction to determine a timestamp and recording timestamp or other timing data.

In the embodiment of FIG. 2, the computer system 200 includes first logic 206 stored in the memory 204 and executable by the processor 202 to cause the processor 202 to generate a trading interface for the market participant configured to display a trade entry form for entry of data indicative of the financial instrument transaction. The trading interface may correspond with a front-end interface through which the market participant enters trades. The first logic 206 may be implemented as a front-end trading interface module of the computer system 200.

The trade entry form may present a number of time fields for entry of timing data for the transaction. The time fields may be populated manually and/or automatically. In one embodiment, time fields for the order receipt time, the match time, and the execution time are provided. Additional, fewer, or alternative time fields may be provided. For example, order times may not be used in connection with certain block trades. In some embodiments, the execution time is displayed on each trade entry form for population before submission to clearing. A user may be given the option of automatically synchronizing or otherwise allocating the current time to one or more of the time fields. A user may also be given the option of updating the execution time to address the lack of an agreement as to one or more leg prices or correct other errors.

The computer system 200 further includes second logic 208 stored in the memory 204 and executable by the processor 202 to cause the processor 202 to capture data indicative of a timing of the financial instrument transaction based on the data entered via the trading interface. The timing data may include or be configured as a timestamp (e.g., an execution timestamp) for the transaction. The timestamp may indicate the time at which the transaction is finalized and/or executed. For example, the timestamp may indicate the time at which each leg of a block trade is finalized. In this embodiment, the second logic 208 is further executable by the processor 202 to cause the processor 202 to record a current time at which the financial instrument transaction is finalized.

The second logic 208 may be implemented as a timestamp or other transaction monitoring module of the computer system 200. In some cases, the second logic 208 is part of a broader monitoring logic unit of the computer system 200. For example, other aspects of the transaction may be monitored in addition to the price data and the extent to which the transaction is finalized.

The computer system 200 further includes third logic 210 stored in the memory 204 and executable by the processor 202 to cause the processor 202 to generate a trade book interface, such as the trade book interface described and shown in connection with FIG. 5. A trade book interface may be generated to display the data for each recent or other transaction associated with the market participant. The data displayed for each transaction may include the data entered via the trading interface, as well as the timing data.

In the embodiment of FIG. 2, the third logic 210 is implemented as a trade book interface module of the computer system 200. Alternatively, the trade book interface module may be integrated with the front-end trading interface module and/or any other modules directed to generating a user interface for the market participant. Such integration of the modules may be in addition to any integration of the interfaces themselves.

The computer system 200 further includes fourth logic 212 stored in the memory 204 and executable by the processor 202 to cause the processor 202 to determine a timeframe for reporting a price of the transaction. The timeframe is determined based on the timing data. For example, the timeframe may correspond with the time period in which the transaction price information is to be reported. The time period may be specified by government or other regulations, exchange rules, and/or other rules or guidelines. The time period may begin with the finalization of the transaction, the timing of which may be captured by the second logic.

The fourth logic 212 may also determine a time relative to the timeframe for reporting. In this embodiment, the fourth logic 212 is implemented as a timer module configured to provide a countdown or other timer relative to the time period or timeframe. For example, the timer module may provide data indicative of the time remaining in the timeframe or an indication of the time elapsed in the time frame. The timer module may increment or decrement the time indication. Such data may be referred to herein as countdown timer data regardless of whether the timer of the fourth logic 212 is counting up (incrementing) or down (decrementing).

A representation of the countdown timer data is presented via the trade book interface generated by the third logic 210. The third logic 210 may thus be configured to incorporate the representation of the countdown timer data into the trade book interface. The countdown timer data may be represented by a respective clock or timer for each transaction listed in the trade book interface.

The representation of the countdown timer data may vary based on the time relative to the timeframe (e.g., the time remaining in the time period to report the transaction data). For example, the representation of the countdown timer may change to indicate that the end of the timeframe is imminent or has been passed. In some embodiments, the third logic 210 may cause the processor 202 to update an appearance of the countdown timer based on the time relative to the timeframe. For example, the background color of the trade book interface for the countdown timer may be updated. The location of the countdown timer in the trade book interface may be updated based on the time relative to the reporting deadline. An order in which the trades are listed may be updated once the timeframe lapses.

In some cases, the fourth logic 212 is configured to incorporate the countdown timer data into the trade book interface. Any combination of the third logic 210 and the fourth logic 212 may be directed to providing one or more aspects of the representation of the countdown timer data.

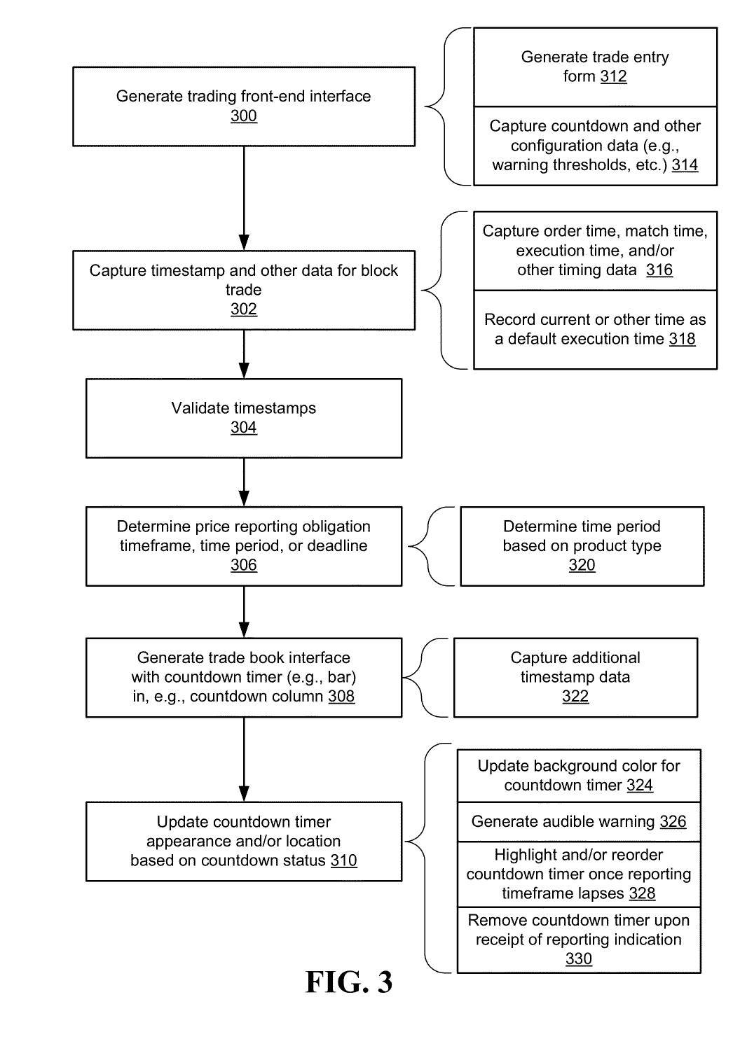

FIG. 3 depicts a flow chart showing operation of the computer system 200 of FIG. 2. In particular, FIG. 3 shows a computer-implemented method of facilitating a financial instrument transaction. The method may manage or otherwise facilitate such transactions by providing a countdown timer to help a market participant meet a reporting obligation. The operation of the system 200 includes: rendering or otherwise generating a trading front-end interface for the market participant [block 300]; capturing data indicative of a timing of the transaction (e.g., a timestamp for a trade, such as a block trade) [block 302]; validating timing data (e.g., the entry of timestamp(s) and the relative values thereof, such as execution time being later than match time) [block 304]; determining a deadline or other timeframe of a reporting obligation for the transaction [block 306]; generating a trade book interface with a countdown timer [block 308]; and updating the countdown timer based on a status of the countdown [block 310].

In some embodiments, the generation of the trading front-end interface includes generating a trade entry form [block 312] or other interface element configured for entry of data indicative of the transaction. The transaction data may be indicative of instrument type, price, quantity, and other parameters. In some cases, the entry of a specific instrument type may lead to capturing configuration data regarding the reporting of the transaction [block 314]. For example, the configuration data may be countdown configuration data that specifies the timeframe or time period in which the transaction is to be reported (e.g., 15 minutes). Other countdown-related configuration data may be alternatively or additionally captured, including, for instance, the threshold time(s) at which warnings are provided.

In some embodiments, the capture of timing data for the transaction includes capturing order time, match time, and/or other timing data indicative of the time at which the transaction is finalized [block 316]. The timing data may be manually be entered via the trading front-end interface or automatically captured. In some cases, the capture of timing data includes recording the current time (or a time relative thereto) as a default time for the order time, match time, or other time [block 318]. The recording may be triggered via the entry or other capture of other transaction data (e.g., price and quantity data). To the extent that default time or other data is automatically entered for any one or more of these fields, a user may then be provided with an opportunity to override the default time or other data before the transaction data is stored, reported, or otherwise processed.

In some embodiments, the reporting obligation determination includes determining a time period for reporting the transaction based on the type of financial product(s) or instrument(s) involved in the transaction [block 320]. Different instruments or markets may have different reporting obligations. The time period may be determined by accessing a look-up table, database, or other data structure. The location of the data structure may vary. For example, the time period determination may include a communication link between the exchange computer system and the computer device of the market participant.

In some embodiments, the generation of the trade book interface includes capturing additional timestamp data [block 322]. For example, the timestamp data may be updated or otherwise modified via the trade book interface. Such modifications may be warranted if, for instance, the timing data captured for the transaction is incorrect.

The trade book interface may present the transaction data in a table. For example, each transaction is listed in a respective row, while the transaction data is distributed over a number of columns, including a column for countdown data. Other data arrangements may be used.

In some embodiments, the updating of the countdown timer includes updating an appearance and/or location of the countdown timer based on the status of the countdown. The status of the countdown may be represented by an elapsed time, time remaining, or other time relative to the time at which the transaction is finalized. As shown in FIG. 4, a background color of the countdown timer may be updated [block 324], an audible warning may be generated [block 326], the countdown timer ay be reordered once the reporting time frame lapses [block 328], and the countdown timer may be removed upon receipt of an indication that the transaction has been reported [block 330].

The blocks of the above-described method may be implemented in an order other than as shown. For example, portions of the trade book interface may be generated before the reporting timeframe is determined. Additional, fewer, or alternative blocks may be implemented. For example, the method need not include a separate step or block in which the timestamp data is verified.

One or more modules described herein may be implemented using, among other things, a tangible computer-readable storage medium comprising computer-executable instructions (e.g., executable software code). Alternatively, modules may be implemented as software code, firmware code, hardware, and/or a combination of the aforementioned. For example the modules may be embodied as part of an exchange system 100 for financial instruments.

Referring to FIG. 4, an illustrative embodiment of a general computer system 400 is shown. The computer system 400 can include a set of instructions that can be executed to cause the computer system 400 to perform any one or more of the methods or computer-based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, order processing, margining, and/or other function on behalf of an Exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable storage medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable storage medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable storage medium is shown to be a single medium, the term “computer-readable storage medium” includes a single medium or multiple media, such as a centralized or distributed database, and/or associated caches and servers that store one or more sets of instructions. The term “computer-readable storage medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable storage medium can include a solid-state memory such as a memory card or other package that houses one or more non-volatile read-only memories. Further, the computer-readable storage medium can be a random access memory or other volatile re-writable memory. Additionally, the computer-readable storage medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable storage medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

FIG. 5 provides an exemplary implementation of a trade book interface 500 in accordance with one embodiment. As described above, one or more aspects of the trade book interface 500 may be directed to facilitating the reporting of price information in connection with block trades and other transactions. The generation of the trade book interface 500 may also improve the processing time for such trades and transactions. The trade book interface 500 may be generated within an electronic trading system, such as the above-referenced CME Direct electronic trading system. Trade book information may be presented by the trade book interface 500 for a number of trades associated with a particular trader or other market participant. In this embodiment, the trade book interface 500 is configured as a table having columns 502 and 504 for the execution time and countdown timer for each trade, respectively. The countdown timer for each transaction may be configured as a countdown bar. The countdown timer may include a display of a value for the time remaining for the trade to be reported. In this example, the time value is disposed within the countdown bar. The value may indicate the amount of time remaining for the trade to be reported. Alternatively, the time value may count upward from zero time (e.g., 00:00).

The countdown timer may begin once the execution time for a trade is entered (e.g., via the trade entry form), saved, and/or otherwise captured. For example, an oil futures trade (e.g., WTI futures) has a minimum reporting time of 15 minutes for all block trades. If a block trade is input into a trade entry form (e.g., the CME Direct interface) with an execution time of 14:00:00, the countdown timer tracks time for 15 minutes from 14:00:00. In some cases, the countdown may begin regardless of whether the trade has been populated with all trade information (e.g., price, quantity, and/or other information). For example, if a trade is saved with an execution time, the countdown begins regardless of whether any other data is missing. The time displayed in the countdown column 504 may be generated from the time tracked by the countdown timer. The exemplary trade book interface 500 is provided within the context of futures contracts with the understanding that the disclosed methods and systems are well suited for other markets, financial instruments, and contexts.

If the countdown time elapses, the price information has not yet been submitted, and/or the trade has not yet been submitted to clearing, the countdown bar may display a time that counts up from 00:00. This time may be displayed in a manner to indicate to the trader that the time allowed to report a trade has been exceeded by the amount shown.

In some embodiments, the trades may be sorted or listed in the trade book interface 500 based on whether the time period for reporting has elapsed. For example, the trades that have exceeded the reporting time period may be displayed at the top, with the oldest (or most overdue) trade first. Other trades that are still counting down may then be listed. The trades in the midst of the countdown may also be sorted. For example, a user may sort trades with the least time remaining at the top. Such sorting may result in a reordering of the trades during operation, as described herein.

Formats other than the countdown bar may be used for the countdown timer. For example, an hourglass-shaped icon may be used. The countdown timer may display the time remaining in ways other than within a countdown bar.

The trade book interface 500 includes additional columns for displaying and/or specifying additional parameters or characteristics of each trade. In this example, columns are provided for trade type (e.g., block or non-block), product or instrument, term, price, and quantity. Other parameters of the trade may be specified (e.g., via additional columns and/or additional interface displays). For example, other timing data may be presented in additional columns. In some embodiments, a column may be provided for the order receipt time.

During operation, one or more characteristics of the countdown timers may be updated to provide status information regarding the reporting obligation. In the example of FIG. 5, the length of the countdown bar is updated to indicate the time remaining to meet the price reporting obligation. As shown in the example of FIG. 5, the countdown bar for a trade having 0 minutes, 59 seconds, remaining for reporting is shorter than the countdown bar for a trade having 10 minutes, 59 seconds, remaining.

A background color of the countdown bar may also or additionally be indicative of the time remaining. For example, the countdown bar may change to orange once the time remaining reaches a threshold, such as two minutes remaining in the reporting timeframe. The countdown bar may change to another color (e.g., red) once another threshold is reached, or once the reporting timeframe has elapsed. Any number of colors and timing thresholds may be used as the reporting deadline approaches. The trade book interface 500 may be configured to allow a user to define the thresholds, colors, and other characteristics of the countdown timer and/or other element of the trade book interface 500.

Other visual indicators may be provided via the column 504 for the countdown timer. In some embodiments, hovering a pointer or other tool tip over the column 504 may provide a pop-up or other interface element that displays the time remaining and/or further information regarding the countdown timing. For example, a trade with 01:25 displayed via the countdown bar may have a pop-up that displays the following text: “Block Trade: 1 minute, 25 seconds to Report.” The text of the pop-up may vary.

The trade book interface 500 may allow the execution time (or other timing data, such as the match time) to be edited, updated, or otherwise specified without involving other edits to the trade information. In this embodiment, the trade book interface 500 includes a toolbar having a “Stamp” button 506 and an “Edit” button 508. The selection of the buttons 506 and 508 may be used to specify a time value for a highlighted entry. For example, the Stamp button 506 may be used to populate an entry with the current time. Timestamps or other timing data may be specified in additional or alternative ways.

In some embodiments, the functionality of the countdown timer is directed to providing a visual indication of the time remaining for reporting. In some cases, the computer system takes no action beyond those involving generating the trade book interface 500 and communicating with the Exchange (or other modules thereof). Other actions, such as a trader fine, may be taken by the Exchange based on a subsequent determination that the reporting obligation timeframe was not met. Such other actions may be taken based upon an analysis of the timing data or based on other countdown timing administered by the Exchange or another computer system.

The trade book interface 500 may be configured to provide audible indications of the countdown timing in addition to the above-described visual indications. For example, the trade book interface 500 may emit warning or other alert sounds when one or more timing thresholds are reached. The alert sounds may vary.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of facilitating a financial instrument transaction involving a market participant, the method comprising:
generating a first interface for the market participant configured for entry of data indicative of the financial instrument transaction;
capturing data indicative of a timing of the financial instrument transaction based on the data entered via the first interface;
determining, with a processor, a timeframe for reporting a price of the financial instrument transaction based on the data indicative of the timing; and
generating a second interface for the market participant in which a timer is displayed, the timer being configured to display a time relative to the timeframe.

2. The computer implemented method of claim 1 further comprising updating an appearance of the timer based on the time relative to the timeframe.

3. The computer implemented method of claim 2 wherein updating the appearance comprises updating a background color of the second interface for the timer.

4. The computer implemented method of claim 1 further comprising generating an audible warning based on the time relative to the timeframe.

5. The computer implemented method of claim 1 further comprising updating a location of the countdown timer in the second interface based on the time relative to the timeframe.

6. The computer implemented method of claim 5 wherein updating the location comprises changing an ordering in the second interface for the timer once the timeframe lapses.

7. The computer implemented method of claim 1 wherein capturing the data indicative of the timing comprises recording a current time at which the financial instrument transaction is finalized.

8. The computer implemented method of claim 1 wherein the financial instrument transaction comprises a block trade.

9. The computer implemented method of claim 1 wherein:
the first interface is configured to display a trade entry form; and
the second interface is configured to display trade book data for the market participant.

10. A system to facilitate a financial instrument transaction involving a market participant, the system comprising a processor and a memory coupled with the processor, the system further comprising:
first logic stored in the memory and executable by the processor to generate a trading interface for the market participant configured to display a trade entry form for entry of data indicative of the financial instrument transaction;
second logic stored in the memory and executable by the processor to capture data indicative of a timing of the financial instrument transaction based on the data entered via the trading interface;
third logic stored in the memory and executable by the processor to generate a trade book interface for the market participant to display the data entered via the trading interface and the data indicative of the timing;
fourth logic stored in the memory and executable by the processor to determine a timeframe for reporting a price of the financial instrument transaction based on the data indicative of the timing;
wherein the trade book interface comprises a timer to display a time relative to the timeframe.

11. The system of claim 10 wherein the third logic is further executable by the processor to cause the processor to update an appearance of the timer based on the time relative to the timeframe.

12. The system of claim 10 wherein the third logic is further executable by the processor to cause the processor to update a background color of the trade book interface for the timer.

13. The system of claim 10 wherein the third logic is further executable by the processor to cause the processor to update a location of the timer in the trade book interface based on the time relative to the timeframe.

14. The system of claim 10 wherein the third logic is further executable by the processor to cause the processor to change an ordering in the trade book interface for the timer once the timeframe lapses.

15. The system of claim 10 wherein the second logic is further executable by the processor to cause the processor to record a current time at which the financial instrument transaction is finalized.

16. A computer program product to facilitate a financial instrument transaction involving a market participant, the computer program product comprising one or more computer-readable storage media having stored thereon computer-executable instructions that, when executed by one or more processors of a computing system, cause the computing system to perform the method, the method comprising:
generating a trading interface for the market participant configured to display a trade entry form for entry of data indicative of the financial instrument transaction;
capturing data indicative of a timing of the financial instrument transaction based on the data entered via the trading interface;
determining a timeframe for reporting a price of the financial instrument transaction based on the data indicative of the timing; and
generating a trade book interface for the market participant in which a timer is displayed, the countdown timer being configured to display a time relative to the timeframe.

17. The computer program product of claim 16 wherein the method further comprises updating an appearance of the timer based on the time relative to the timeframe.

18. The computer program product of claim 16 wherein the method further comprises updating a background color of the trade book interface for the timer.

19. The computer program product of claim 16 wherein the method further comprises updating a location of the timer in the trade book interface based on the time relative to the timeframe.

20. The computer program product of claim 16 wherein the method further comprises changing an ordering in the trade book interface for the timer once the timeframe lapses.
